(19) United States
(12) Patent Application Publication
(10) Pub. No.: US 2001/0019463 A1
(43) Pub. Date: Sep. 6, 2001

(54) Head loading and unloading method and device

(75) Inventor: David Drouin, Milpitas, CA (US)

Correspondence Address: TOWNSEND AND TOWNSEND AND CREW, TWO EMBARCADERO CENTER, EIGHTH FLOOR, SAN FRANCISCO, CA, 94111-3834, US

(73) Assignee: Castlewood Systems, Inc.

(21) Appl. No.: 09/751,705

(22) Filed: Dec. 29, 2000

Related U.S. Application Data
(63) Continuation of application No. 09/082,425, filed on May 20, 1998, now abandoned.
(60) Provisional application No. 60/066,004, filed on Nov. 14, 1997.

(51) Int. Cl. G11B 21/02

(52) U.S. Cl. 360/75

(57) ABSTRACT

A method for repositioning a read/write head from a parking location to a position adjacent a surface of a magnetic disk, the read/write head disposed on an actuator arm having a voice coil motor, includes the receiving the read/write head load signal, applying a first current pulse to the voice coil motor in response to the read/write head load signal, the first current pulse having a first amplitude and a first duration, determining a back electro-motive force in the voice coil motor, determining a read/write head velocity in response to the back electromotive force, determining the difference between the read/write head velocity and a desired read/write head velocity, using the difference between the read/write head velocity and the desired read/write head velocity to determine a second duration for a second current pulse, and applying the second current pulse to the voice coil motor.

This present application is a continuation application of U.S. patent application Ser. No. 09/082,425 filed May 20, 1998, which is incorporated by reference. The present application also claims the benefit of U.S. Provisional Application No. 60/066,004 filed Nov. 14, 1997, which is incorporated by reference.

### BACKGROUND OF THE INVENTION

The present invention generally relates to removable storage devices for electronic information. More particular, the present invention provides a technique including an apparatus and methods for the movement and operation of a storage device including a magnetic head used to read and write data into a removable disk.

Consumer electronics including television sets, personal computers, and stereo or audio systems, have changed dramatically since their availability. Television was originally used as a stand alone unit in the early 1900's, but has now been integrated with audio equipment to provide video with high quality sound in stereo. For instance, a television set can have a high quality display coupled to an audio system with stereo or even “surround sound” or the like. This integration of television and audio equipment provides a user with a high quality video display for an action movie such as STARWARS™ with “lifelike” sound from the high quality stereo or surround sound system. Accordingly, the clash between Luke Skywalker and Darth Vader can now be seen as well as heard in surround sound on your own home entertainment center. In the mid-1990's, computer-like functions became available on a conventional television set. Companies such as WebTV of California provide what is commonly termed as “Internet” access to a television set. The Internet is a world wide network of computers, which can now be accessed through a conventional television set at a user location. Numerous displays or “web sites” exist on the Internet for viewing and even ordering goods and services at the convenience of home, where the act of indexing through websites is known as “surfing” the web. Accordingly, users of WebTV can surf the Internet or web using a home entertainment center.

As merely an example, FIG. 1 illustrates a conventional audio and video configuration, commonly termed a home entertainment system, which can have Internet access. FIG. 1 is generally a typical home entertainment system, which includes a video display 10 (e.g., television set), an audio output 20, an audio processor 30, a video display processor 40, and a plurality of audio or video data sources 50. Consumers have often been eager to store and play back pre-recorded audio (e.g., songs, music) or video using a home entertainment system. Most recently, consumers would like to also store and retrieve information, commonly termed computer data, downloaded from the Internet.

Music or audio have been traditionally recorded on many types of systems using different types of media to provide audio signals to home entertainment systems. For example, these audio systems include a reel to reel system 140, using magnetic recording tape, an eight track player 120, which uses eight track tapes, a phonograph 130, which uses LP vinyl records, and an audio cassette recorder 110, which relies upon audio cassettes. Optical storage media also have been recognized as providing convenient and high quality audio play-back of music, for example. Optical storage media exclusively for sound include a digital audio tape 90 and a compact disk 10. Unfortunately, these audio systems generally do not have enough memory or capacity to store both video and audio to store movies or the like. Tapes also have not generally been used to efficiently store and retrieve information from a personal computer since tapes are extremely slow and cumbersome.

Audio and video have been recorded together for movies using a video tape or video cassette recorder, which relies upon tapes stored on cassettes. Video cassettes can be found at the local Blockbuster™ store, which often have numerous different movies to be viewed and enjoyed by the user. Unfortunately, these tapes are often too slow and clumsy to store and easily retrieve computer information from a personal computer. Additional video and audio media include a laser disk 70 and a digital video disk 60, which also suffer from being read only, and cannot be easily used to record a video at the user site. Furthermore, standards for a digital video disk have not been established of the filing date of this patent application and do not seem to be readily establishable in the future.

From the above, it is desirable to have a storage media that can be used for all types of information such as audio, video, and digital data, which have features such as a high storage capacity, expandability, and quick access capabilities.

A typical storage device includes a storage media including a magnetic disk and a read/write head for reading data from the magnetic disk. In a normal, operating mode, the read/write heads are positioned above the data storage portion of the magnetic disk. More particularly, the read/write heads “fly” above the surface of the magnetic disk and never physically touch the data storage portion of the magnetic disk. The position of the read/write heads is typically controlled by varying the amount of voltage and current applied to a solenoid (voice coil motor) positioned upon an opposite end of an actuator arm holding the read/write heads.

Upon power-down of a typical storage device, the read/write heads are typically moved from a position above the data storage portion of the magnetic disk to a safe position. This safe position is typically not above the storage portion, but at a crash landing region located at either the inner or outer diameter of the disk; a head load/unload ramp, often located outside the outer diameter of the disk; and the like. When a head load/unload ramp is used, the read/write heads are typically deflected vertically away from the surface of the magnetic disk as the read/write heads are moved horizontally from the outer diameter of the magnetic disk.

Upon power-up of a typical storage device, the read/write heads are typically moved from the safe position to a position above the data storage portion of the magnetic disk. When the position of the read/write heads on the load/unload ramp is unpredictable, because of variations in unloading conditions, loading of the read/write heads back upon the surface of the magnetic disk must be performed carefully. If the read/write heads are not carefully loaded onto the magnetic disk, the read/write heads may bounce on the magnetic disk during the loading because of the vertical deflection caused by parking onto the load/unload ramp. If the heads are loaded too quickly, damage may occur to data storage portions of the magnetic disk, misalignments may occur to the read/write heads, damage may occur to the read/write elements, and the like. A typical amount of time for loading read/write heads onto a magnetic disk from a load/unload ramp is on the order of a half of a second, although this time may vary.

The amount of energy applied to the voice coil motor (VCM) to load the read/write heads often varies greatly because of the variation of the parking position of the read/write heads on the load/unload ramp. Further, the amount of energy also varies because static friction of load/unload ramps often unique, is greater than designed for, is non-linear, and the like. If too much energy is applied to the VCM to load the read/write heads, they may bounce upon the magnetic disk and cause the damage described above. If too little energy is used, the read/write heads may not be loaded, and the loading process must be repeated making the use wait.

One solution to lessen the above read/write head loading problems has been to move the read/write heads down the load/unload ramp and to the magnetic disk at a constant velocity. One exemplary embodiment to perform this solution has been to apply a series of current pulses at a fixed frequency to the VCM.

One drawback to the above solution has been that the series of current pulses applied to the VCM often causes an audible noise. In particular, the series of current pulses often causes a noticeable noise best described as a “skreetch”, when the heads are loaded onto the magnetic disk. Users of such devices are often perturbed by such “strange” noises coming from storage devices using the above solution. Often users believe that such noises indicate that the storage device is broken or will break soon, that the device is destroying the users data or that the device is “a piece of junk”, and the like. As a result, the manufacturer's reputation with the user and others may be harmed and may result in fewer sales.

Thus what is required are methods and apparatus for providing more reliable loading of read/write heads to protect the read/write heads as well as the disk media without the drawbacks discussed above.

### SUMMARY OF THE INVENTION

According to the present invention, a technique including methods and devices for providing a single type of media for electronic storage applications is provided. In an exemplary embodiment, the present invention provides a methods and apparatus for loading of MR heads from a load/unload ramp to the surface of the removable media.

According to an embodiment of the present invention, a technique for repositioning a read/write head from a parking location to a position adjacent a surface of a magnetic disk, the read/write head disposed on an actuator arm having a voice coil motor, includes the receiving a read/write head load signal, measuring the back EMF voltage of the voice coil motor, and applying a first current pulse to the voice coil motor in response to the read/write head load signal, the first current pulse having a first amplitude and a first duration. The determining a back EMF voltage in the voice coil motor and determining a read/write head velocity in response to the back EMF voltage are also disclosed. The technique also includes the determining a difference between the read/write head velocity and a desired read/write head velocity, using the difference between these two velocities to determine a second duration for a second current pulse, and applying the second current pulse to the voice coil motor.

According to another embodiment of the present invention, a technique for repositioning a read/write head from a position adjacent a surface of a magnetic disk to parking location, the read/write head disposed on an actuator arm having a voice coil motor, includes the receiving a read/write head unload signal, applying a first current pulse to the voice coil motor in response to the read/write head load signal, the first current pulse having a first amplitude and a first duration. The technique also includes the steps of determining a read/write head velocity in response to the first current pulse, comparing the read/write head velocity to a desired read/write head velocity to form a difference velocity, and determining a current amplitude to be applied to the voice coil motor in response to the difference velocity. The determining a second duration for a second current pulse, a second amplitude in response to the second duration and the current amplitude, the second amplitude different from the first amplitude, and applying the second current pulse to the voice coil motor are also disclosed.

According to another embodiment a system having a storage device include a magneto-resistive head for repositioning the magneto-resistive head from a load/unload ramp to a position adjacent a surface of a magnetic disk in response to a load signal is disclosed. The storage device includes an actuator arm having a voice coil motor disposed on one end and the magneto-resistive head disposed on another end, and a voice coil motor driver coupled to the voice coil motor for applying a first current pulse to the voice coil motor, the first current pulse having a first amplitude and a first duration. The storage device also includes a processor coupled to the voice coil motor and to the voice coil motor driver for determining an actual change in back EMF voltage for the voice coil motor in response to the first current pulse, for comparing the actual change in back EMF voltage to a predetermined change in back EMF voltage, for determining a current amplitude to be applied to the voice coil motor in response to comparing the actual change to the predetermined change for determining a second duration for a second current pulse, and for determining a second amplitude for the second current pulse in response to the second duration and to the current amplitude, the second amplitude different from the first amplitude. The voice coil motor driver is also for applying the second current pulse to the voice coil motor.

A further embodiment of the present invention provides a method for repositioning a read/write head from a position adjacent a surface of a magnetic disk to a parking location with reduced audible noise, the read/write head disposed on an actuator arm having a voice coil motor. This method includes receiving a read/write head unload signal, applying a series of current pulses to the voice coil motor in response to the read/write head unload signal until the read/write head reaches the parking location, each current pulse having an amplitude and a duration. After a first number of current pulses, a back electro-motive force voltage in the voice coil motor is determined, from which a read/write head velocity is found. A difference between the read/write head velocity and a desired read/write head velocity is determined, and is used to determine a duration for each of a next first number of pulses, where no two consecutive pulses in the series have the same duration.

A further exemplary embodiment of the present invention provides a method for repositioning a read/write head from a parking location to a position adjacent a surface of a magnetic disk with reduced audible noise, the read/write head disposed on an actuator arm having a voice coil motor. This method provides for receiving a read/write head load signal, and applying a series of current pulses to the voice coil motor in response to the read/write head load signal until the read/write head reaches the position adjacent a surface of a magnetic disk, each current pulse having an amplitude and a duration. After a first number of current pulses, a back electromotive force voltage in the voice coil motor is determined, from which a read/write head velocity is found. A difference between the read/write head velocity and a desired read/write head velocity is determined, and is used to determine a duration for each of a next first number of pulses, where no two consecutive pulses in the series have the same duration.

Depending upon the embodiment, the present invention provides at least one of these if not all of these benefits and others, which are further described throughout the present specification.

Further understanding of the nature and advantages of the invention may be realized by reference to the remaining portions of the specification and drawings.

### BRIEF DESCRIPTION OF THE DRAWINGS

FIG. 1 illustrates a conventional audio and video configuration;

FIG. 2 illustrates a system according to an embodiment of the present invention;

FIG. 3 includes a detailed block diagram of a system 200 according to an embodiment of the present invention;

FIGS. 4A and 4B illustrate a storage unit according to an embodiment of the present invention;

FIGS. 5A-5F illustrate simplified views and a storage unit for reading and/or writing from a removable media cartridge;

FIG. 6 illustrates a functional block diagram of an embodiment of the present invention;

FIG. 7 illustrates a functional block diagram of a circuit for loading read/write heads from the magnetic disk and onto a loading/unloading ramp;

FIG. 8 illustrates a block diagram of a method for loading heads according to an embodiment of the present invention;

FIG. 9 illustrates a block diagram of a method for unloading heads according to an embodiment of the present invention;

FIG. 10 illustrates a block diagram of an embodiment for determining a current magnitude;

FIG. 11 illustrates a typical embodiment of the present invention, and

FIGS. 12 and 13 illustrate two examples according to embodiments of the present invention.

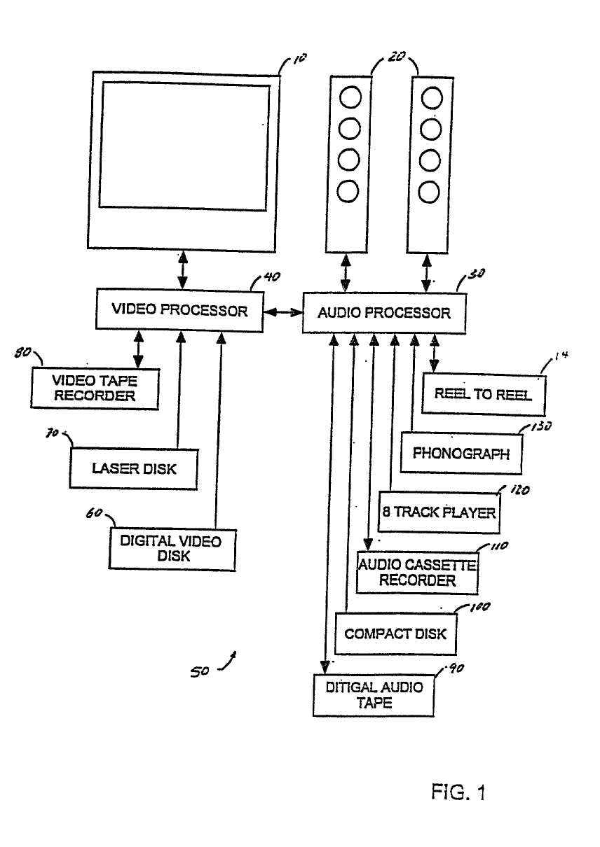

### DESCRIPTION OF THE SPECIFIC EMBODIMENTS

System Overview

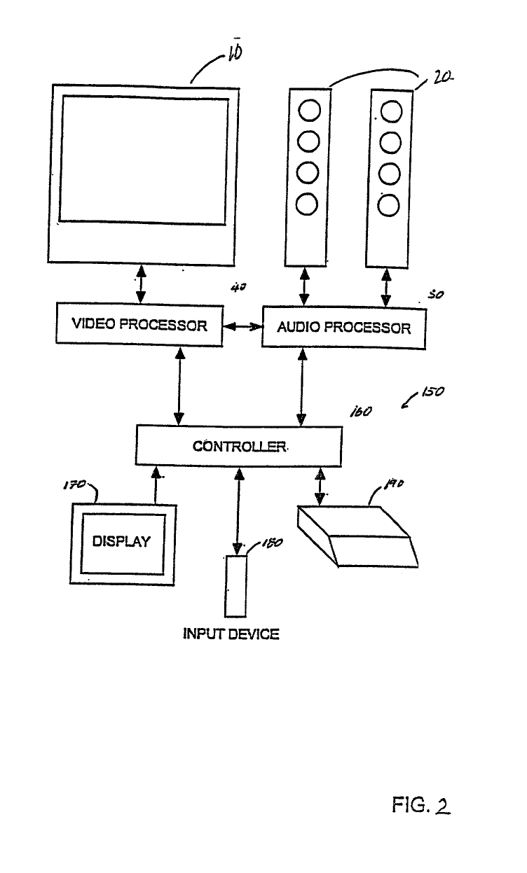

FIG. 2 is a simplified block diagram of a system according to an embodiment of the present invention. This embodiment is merely an illustration and should not limit the scope of the claims herein. The system 150 includes the television display 10, which is capable of Internet access or the like, the audio output 20, a controller 160, a user input device 180, a novel storage unit 190 for storing and accessing data, and optionally a computer display 170. Output from system 150 is often audio and/or video data and/or data that is generally input into audio processor 30 and/or video processor 40.

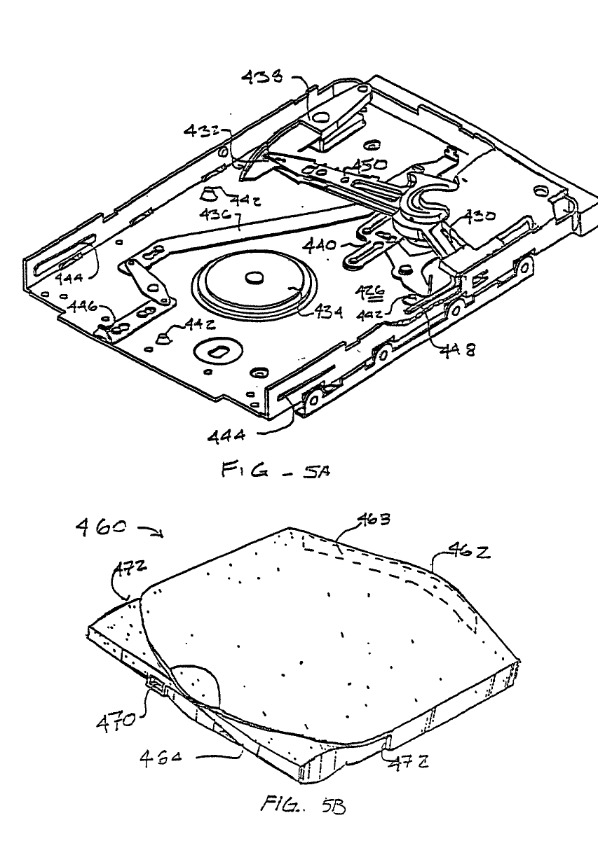

The storage unit includes a high capacity removable media cartridge, such as the one shown in FIGS. 5B & 5C, for example. The removable media cartridge can be used to record and playback information from a video, audio, or computer source. The cartridge is capable of storing at least 2 GB of data or information. The cartridge also has an efficient or fast access time of about 13 ms and less, which is quite useful in storing data for a computer. The cartridge is removable and storable. For example, the cartridge can store up to about 18 songs, which average about 4 minutes in length. Additionally, the cartridge can store at least 0.5 for MPEGII-2 for MPEGI full length movies, which each runs about 2 hours. Furthermore, the cartridge can be easily removed and stored to archive numerous songs, movies, or data from the Internet or the like. Accordingly, the high capacity removable media provides a single unit to store information from the video, audio, or computer. Further details of the storage unit are provided below.

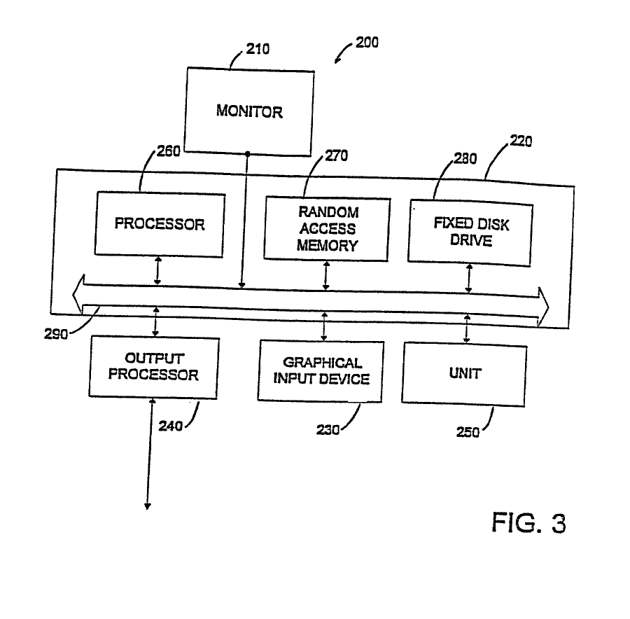

In an alternative embodiment, FIG. 3 is a simplified block diagram of an audio/video/computer system 200. This diagram is merely an illustration and should not limit the scope of the claims herein. The system 200 includes a monitor 210, a controller 220, a user input device 230, an output processor 240, and a novel electronic storage unit 250 preferably for reading and writing from a removable media source, such as a cartridge. Controller 220 preferably includes familiar controller components such as a processor 260, and memory storage devices, such as a random access memory (RAM) 270, a fixed disk drive 280, and a system bus 290 interconnecting the above components.

User input device 230 may include a mouse, a keyboard, a joystick, a digitizing tablet, a wireless controller, or other graphical input devices, and the like. RAM 270 and fixed disk drive 280 are mere examples of tangible media for storage of computer programs and audio and/or video data, other types of tangible media include floppy disks, optical storage media such as CD-ROMs and bar codes, semiconductor memories such as flash memories, read-only-memories (ROMs), ASICs, battery-backed volatile memories, and the like. In a preferred embodiment, controller 220 includes a '586 class microprocessor running Windows95™ operating system from Microsoft Corporation of Redmond, Washington. Of course, other operating systems can also be used depending upon the application.

The systems above are merely examples of configurations, which can be used to embody the present invention. It will be readily apparent to one of ordinary skill in the art that many system types, configurations, and combinations of the above devices are suitable for use in light of the present disclosure. For example, in alternative embodiments of FIG. 2, for example, video display 10 is coupled to controller 220 thus a separate monitor 210 is not required. Further, user input device 230 also utilizes video display 10 for graphical feedback and selection of options. In yet other embodiments controller 220 is integrated directly into either audio processor 20 or video processor 30, thus separate output processor 240 is not needed. In another embodiment, controller 220 is integrated directly into video display 10. Of course, the types of system elements used depend highly upon the application.

### DETAILED DESCRIPTION

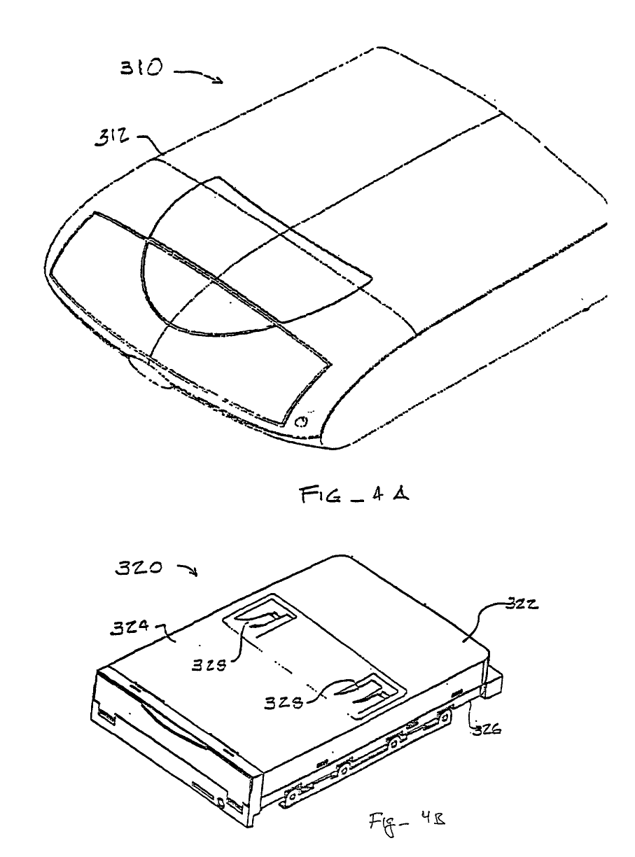

Referring now to FIGS. 4A and 4B, a storage unit according to the present embodiment can be an external disk drive 310 or internal disk drive 320 unit, which shares many of the same components. However, external drive 310 will include an enclosure 312 adapted for use outside a personal computer, television, or some other data manipulation or display device. Additionally, external drive 310 will include standard I/O connectors, parallel ports, and/or power plugs similar to those of known computer peripheral or video devices.

Internal drive 320 will typically be adapted for insertion into a standard bay of a computer. In some embodiments, internal drive 310 may instead be used within a bay in a television set such as HDTV, thereby providing an integral video system. Internal drive 320 may optionally be adapted for use with a bay having a form factor of 3 inches, 2.5 inches, 1.8 inches, 1 inch, or with any other generally recognized or proprietary bay. Regardless, internal drive 320 will typically have a housing 322 which includes a housing cover 324 and a base plate 326. As illustrated in FIG. 4B, housing 324 will typically include integral springs 328 to bias the cartridge downward within the receiver of housing 322. It should be understood that while external drive 310 may be very different in appearance than internal drive 320, the external drive will preferably make use of base plate 326, cover 324, and most or all mechanical, electromechanical, and electronic components of internal drive 320.

Many of the components of internal drive 320 are visible when cover 322 has been removed, as illustrated in FIG. 5A. In this exemplary embodiment, an actuator 450 having a voice coil motor 430 positions first and second heads 432 along opposed recording surfaces of the hard disk while the disk is spun by spindle drive motor 434. A release linkage 436 is mechanically coupled to voice coil motor 430, so that the voice coil motor effects release of the cartridge from housing 422 when heads 432 move to a release position on a head load ramp 438. Head load ramp 438 is preferably adjustable in height above base plate 426, to facilitate aligning the head load ramp with the rotating disk.

A head retract linkage 440 helps to ensure that heads 432 are retracted from the receptacle and onto head load ramp 438 when the cartridge is removed from housing 422. Head retract linkage 440 may also be used as an inner crash stop to mechanically limit travel of heads 432 toward the hub of the disk.

Base 426 preferably comprise a stainless steel sheet metal structure in which the shape of the base is primarily defined by stamping, the shape ideally being substantially fully defined by the stamping process. Bosses 442 are stamped into base 426 to engage and accurately position lower surfaces of the cartridge housing. To help ensure accurate centering of the cartridge onto spindle drive 434, rails 444 maintain the cartridge above the associated drive spindle until the cartridge is substantially aligned axially above the spindle drive, whereupon the cartridge descends under the influence of cover springs 428 and the downward force imparted by the user. This brings the hub of the disk down substantially normal to the disk into engagement with spindle drive 434. A latch 446 of release linkage 436 engages a detent of the cartridge to restrain the cartridge, and to maintain the orientation of the cartridge within housing 422.

A cartridge for use with internal drive 320 is illustrated in FIGS. 5B and 5C. Generally, cartridge 460 includes a front edge 462 and rear edge 464. A disk 666 (see FIG. 5F) is disposed within cartridge 460, and access to the disk is provided through a door 568. A detent 470 along rear edge 464 of cartridge 460 mates with latch 446 to restrain the cartridge within the receptacle of the drive, while rear side indentations 472 are sized to accommodate side rails 444 to allow cartridge 460 to drop vertically into the receptacle.

Side edges 574 of cartridge 460 are fittingly received between side walls 576 of base 526, as illustrated in FIG. 5D. This generally helps maintain the lateral position of cartridge 460 within base 426 throughout the insertion process. Stops 578 in sidewall 576 stop forward motion of the cartridge once the hub of disk 666 is aligned with spindle drive 534, at which point rails 444 are also aligned with rear indents 472. Hence, the cartridge drops roughly vertically from that position, which helps accurately mate the hub of the disk with the spindle drive.

FIG. 5F also illustrates a typical first position 667 of VCM 668 and a typical second position 669 in response to different magnetic fluxes from a motor driver. As a result, read/write heads 632 are repositioned relative to disk 666 as shown.

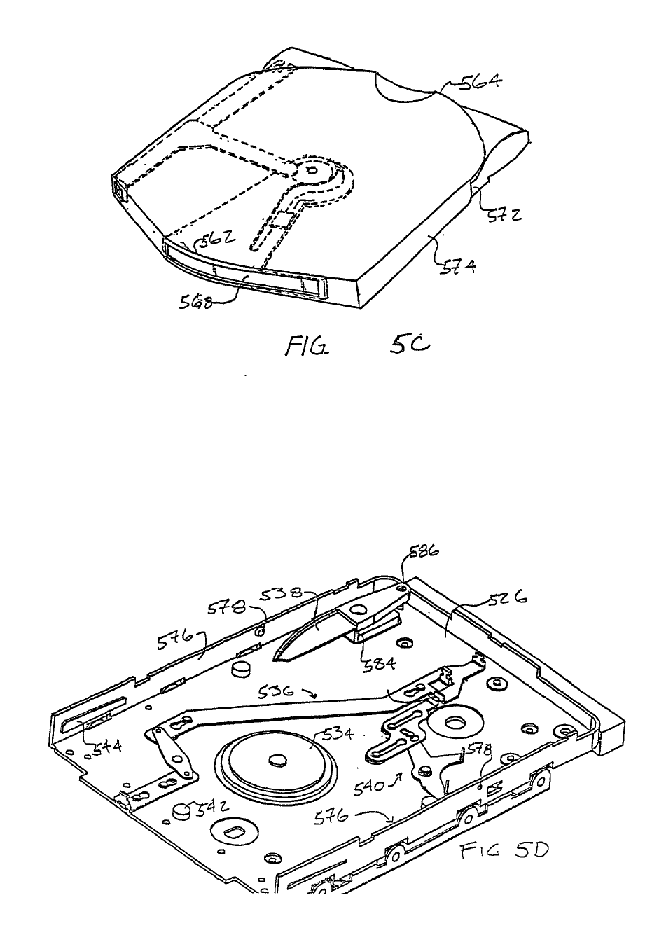

FIG. 6 illustrates a simplified functional block diagram of an embodiment of the present invention. FIG. 6 includes a buffer 700, a control store 710, a read data processor 720, a controller 730, motor drivers 740, a voice coil motor 750, a spindle motor 760, and read/write heads 770. Controller 730 includes interface module 780, an error detection and correction module 790, a digital signal processor 800, and a servo timing controller 810. Voice coil motor 750 preferably corresponds to voice coil motor 430 in FIG. 5A, spindle motor 760 preferably corresponds to spindle drive motor 434 in FIG. 5A, and read/write heads 770 preferably correspond to read/write heads 432 on actuator arm 450 in FIG. 5A.

As illustrated in FIG. 6, buffer 700 typically comprises a conventional DRAM, having 16 bits×64K, 128K, or 256K, although other sized buffers are also envisioned. Buffer 700 is typically coupled to error detection and correction module 790. Buffer 700 preferably serves as a storage of data related to a specific removable media cartridge. For example, buffer 700 preferably stores data retrieved from a specific removable media cartridge (typically a magnetic disk), such as media composition and storage characteristics, the location of corrupted locations, the data sector eccentricity of the media, the non-uniformity of the media, the read and write head offset angles for different data sectors of the media and the like. Buffer 700 also preferably stores data necessary to compensate for the specific characteristics of each removable media cartridge, as described above. Buffer 700 typically is embodied as a 1 Meg DRAM from Sanyo, although other vendors' DRAMs may also be used. Other memory types such as SRAM and flash RAM are contemplated in alternative embodiments. Further, other sizes of memory are also contemplated.

Control store 710 typically comprises a readable memory such as a flash RAM, EEPROM, or other types of nonvolatile programmable memory. As illustrated, typically control store 710 comprises a 8 to 16 bit×64K memory array, preferably a flash RAM by Atmel. Control store 710 is coupled to DSP 800 and servo timing controller 810, and typically serves to store programs and other instructions, as well as data for DSP 800 and servo timing controller 810. Preferably, control store 710 stores access information that enables retrial of the above information from the media and calibration data.

Read data processor 720 typically comprises a Partial Read/Maximum Likelihood (PRML) encoder/decoder. PRML read channel technology is well known, and read data processor 720 is typically embodied as a 81M3010 chip from MARVELL company. Other read data processors, for example from Lucent Technologies are contemplated in alternative embodiments of the present invention. As illustrated, read data processor 720 is coupled to error detection and correction module 790 to provide ECC and data transport functionality.

Interface module 780 typically provides an interface to controller 220, for example. Interfaces include a small computer standard interface (SCSI), an IDE interface, parallel interface, PCI interface or any other known or custom interface. Interface module 780 is typically embodied as an AK-8381 chip from Adaptec, Inc. Interface module 780 is coupled to error detection and correction module 790 for transferring data to and from the host system.

Error detection and correction module 790 is typically embodied as a AIC-8381B chip from Adaptec, Incorporated. This module is coupled by a read/write data line to read data processor 720 for receiving read data and for ECC. This module is also coupled to read data processor 720 by a non-return to zero (NRZ) data and control non-return to zero line. Other vendor sources of such functionality are contemplated in alternative embodiments of the present invention.

DSP 800 typically provides high-level control of the other modules in FIG. 6. DSP 800 is typically embodied as a AIC-4421A DSP from Adaptec, Inc. As shown, DSP 800 is coupled to read data processor 720 to provide control signals for decoding signals read from a magnetic disk. Further, DSP 800 is coupled to servo timing controller 810 for controlling VCM 750 and spindle motor 760. Other digital signal processors can be used in alternative embodiments, such as DSPs from TI or Motorola.

Servo timing controller 810 is typically coupled by a serial peripheral port to read data processor 720 and to motor drivers 740. Servo timing controller 810 typically controls motor drivers 740 according to servo timing data read from the removable media. Servo timing controller 810 is typically embodied in a portion of DSP 800.

Motor driver 740 (or Voice Coil Motor driver) is typically embodied as a L6260L Chip from SGS-Thomson. Motor driver 740 provides signals to voice coil motor 750 and to spindle motor 760 in order to control the reading and writing of data to the removable media.

Spindle motor 760 is typically embodied as an 8 pole Motor from Sankyo Company. Spindle motor 760 typically is coupled to a center hub of the removable media as illustrated in FIG. 4 and rotates the removable media typically at rates from 4500 to 7200 revolutions per minute. Other manufacturers of spindle motor 760 and other rates of revolution are included in alternative embodiments.

VCM 750 is a conventionally formed voice coil motor. Typically VCM 750 includes a pair of parallel permanent magnets, providing a constant magnetic field. VCM 750 also includes an actuator having a voice coil, and read/write heads. Read/write heads are typically positioned near the end of the actuator arm, as illustrated in FIG. 5A. The voice coil is typically electrically coupled to motor driver 740. VCM 750 is positioned relative to the magnetic disk in response to the amount of electric current flowing through the voice coil. FIG. 5F illustrates a typical first position 667 of VCM 668 and a typical second position 669 in response to different magnetic fluxes from motor driver 740. As a result, read/write heads 632 are repositioned relative to disk 666 as shown.

In a preferred embodiment of the present invention read/write heads are separate heads that utilize magneto resistive technology. In particular, the MR read/write heads. Typically a preamplifier circuit is coupled to the read/write heads.

In the preferred embodiment of the present embodiment the removable media cartridge is comprises as a removable magnetic disk. When reading or writing data upon the magnetic disk the read/write heads on the end of the actuator arm “fly” above the surface of the magnetic disk. Specifically, because the magnetic disk rotates at a high rate of speed, typically 5400 rpm, a negative pressure pulls the read/write heads towards the magnetic disk, until the read/write heads are typically 0.001 millimeters above the magnetic disk.

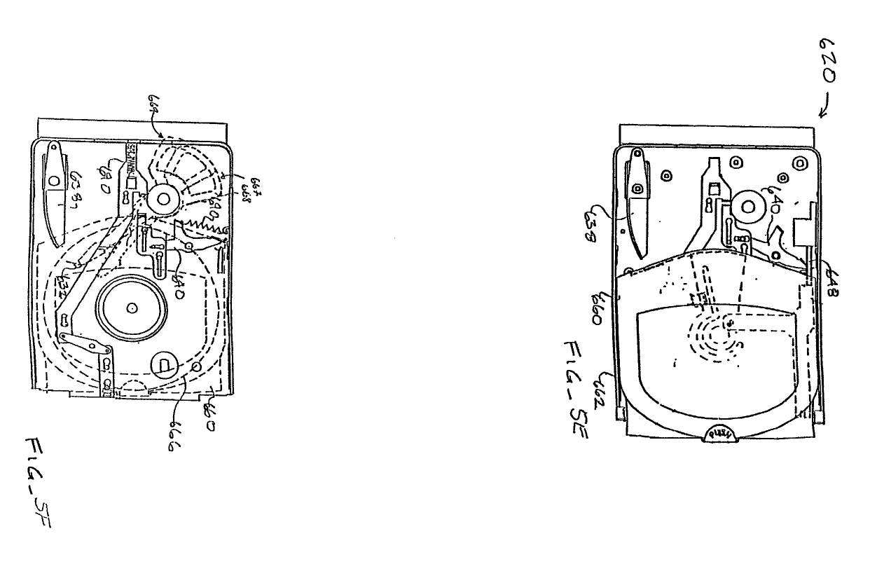

FIG. 7 illustrates a functional block diagram of an embodiment of the present invention. FIG. 7 includes a more detailed block diagram of motor driver 740 above, including a solenoid control 860, and a spindle driver 870 each responsive to a power-on signal 885.

The solenoid 890 represents the voice coil described as part of the VCM 750 above and includes terminals 900 and 910. In one embodiment, solenoid control 860 is the primary control mechanism for positioning of MR heads anywhere above the magnetic disk. In alternative embodiments, solenoid 890 may be coupled to a separate power-on solenoid control by the same or different terminals for conventional power-on operation of solenoid 890 and the actuator arm.

In FIG. 7, the spindle driver 870 provides the drive voltage to the spindle motor to rotate the magnetic disk. During conventional data storage or retrieval, the drive voltage provided to spindle motor is relatively constant such that the magnetic disk spins at approximately the same number of revolutions per time unit (per second, per minute, and the like).

In response to the active power-on signal 885, solenoid control 860 applies a controlled current to solenoid 890 within VCM 750. In response to the control current, MR heads are smoothly loaded onto the magnetic disk, as will be described below.

In a power-off situation, in response to the active power-off signal 880, solenoid control 860 applies a controlled current to solenoid 890 within VCM 750. In response to the control current, MR heads are smoothly unloaded onto a load/unload ramp, as will also be described below.

In the embodiment in FIG. 7, solenoid control 860, spindle driver 870, and other functional components are embodied within voice coil motor driver 740. In one embodiment, motor driver 740 is an L6260L chip from SGS-Thomson. Other motor driver chips from other vendors are also usable in alternative embodiments of the present invention.

In one embodiment of the present invention, the techniques in the presently described invention may be combined with the teaching of co-pending application Ser. No. 09/082,418, filed May 20, 1998, entitled Disk Speed Profile Method and Device, Attorney Docket No. 18525-002500. In particular, the smooth unloading or loading of the MR heads is performed after the magnetic disk reaches an unloading speed (rpm). In the case of loading the MR heads onto the magnetic disk, the magnetic disk reaches an operating speed (rpm) after the MR heads are loaded. The above identified patent application is herein incorporated by reference for all purposes.

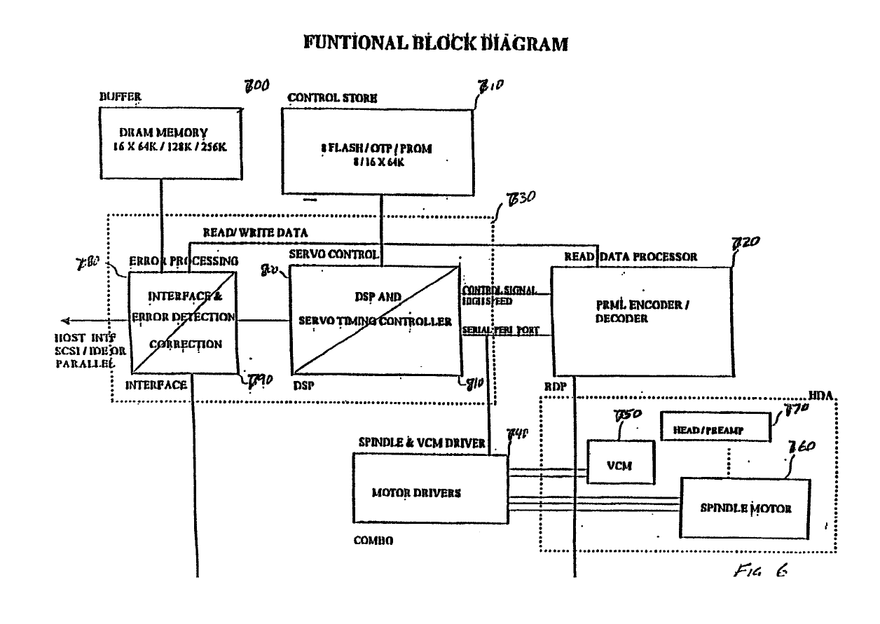

FIG. 8 illustrates a block diagram of a method for loading heads according to an embodiment of the present invention.

Initially, the read/write (MR) heads are parked on the load/unload ramp and the magnetic disk is idle, step 1000.

After detection of a head load command, such as power-on signal 885, step 1010, solenoid driver 860 within voice coil motor driver 740 provides a first current pulse to solenoid 890, step 1020. The first current pulse is characterized by having a first magnitude and a first duration.

After a predetermined amount of time, in response to the first current pulse, the velocity of the MR heads is determined, step 1030. In the present embodiment, this step is performed by determining the back electromotive force (EMF) voltage generated in the voice coil motor 750 (solenoid 890).

In step 1040, the characteristics of the next current pulse are determined. More specifically, DSP 800 determines the duration of the next current pulse. In the first iteration of this step, the next current pulse is the second current pulse, and is characterized by a second magnitude and a second duration.

In the present embodiment of the present invention, the second duration is different from the first duration. In another embodiment, the second magnitude is deliberately different from the first magnitude, and the second duration is also deliberately different from the first duration. In general, it is preferred that any two consecutive current pulses have at least different current durations. By having current durations that are, in general different for adjacent current pulses, the audible noise produced by loading the heads onto the magnetic disk is reduced.

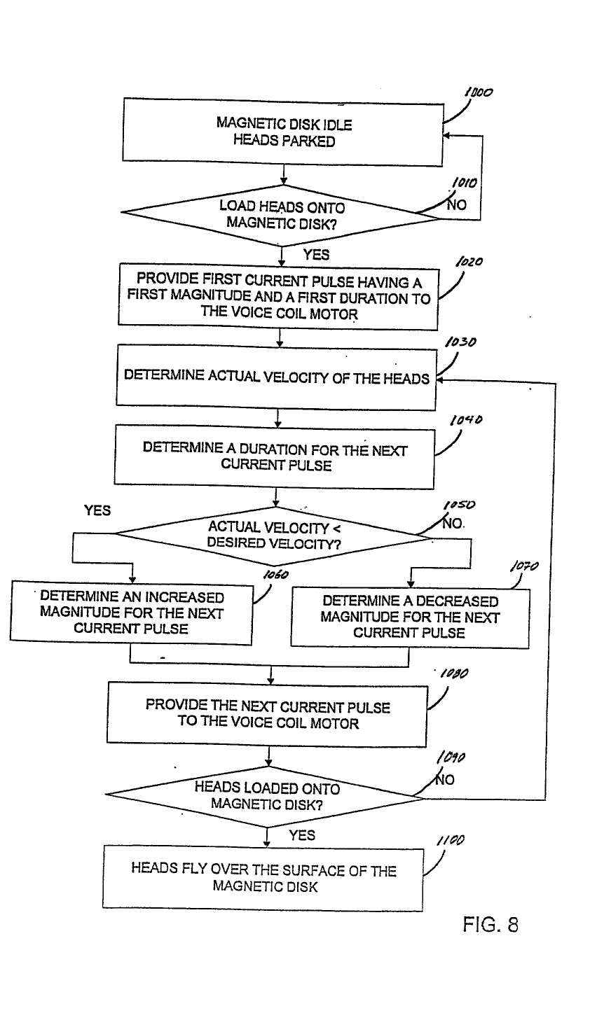

The actual velocity of the MR heads is then compared to a desired velocity, step 1050. In the preferred embodiment, the desired velocity, represented by a value representing a back EMF voltage stored in control store 710, is compared to the actual measured back EMF voltage. When the actual voltage is lower than the desired voltage, the actual velocity is low, and it is typically determined that a larger current magnitude is needed for the next current pulse, step 1060. When the actual voltage is higher than the desired voltage, the actual velocity is high, and it is typically determined that a smaller current magnitude is needed for the next current pulse, step 1070. A method for determining the magnitude for the next current pulse is described in FIG. 10.

After the characteristics of the next current pulse are determined, solenoid control 860 applies the next current pulse to solenoid 890, step 1080. The above process for determining and applying current pulses preferably repeats until the MR heads have been loaded onto the magnetic disk, step 1090.

Once loaded, MR heads fly over the magnetic disk for conventional read and write operations, step 1100. In one embodiment of the present invention, determining when the MR heads are unloaded onto the head load/unload ramp is also performed directly by monitoring data read by the MR heads.

In alternative embodiments of the present invention, the step illustrated may be performed in a different order than that illustrated in FIG. 8.

In alternative embodiments of the present invention step 1020 is not included. In such embodiments, measurement of the velocity is performed before any current pulse is applied. From a parked position, the back EMF voltage of the VCM 750 is zero, thus the velocity is also zero. In such embodiments, it is preferred that two adjacent current pulses have different durations.

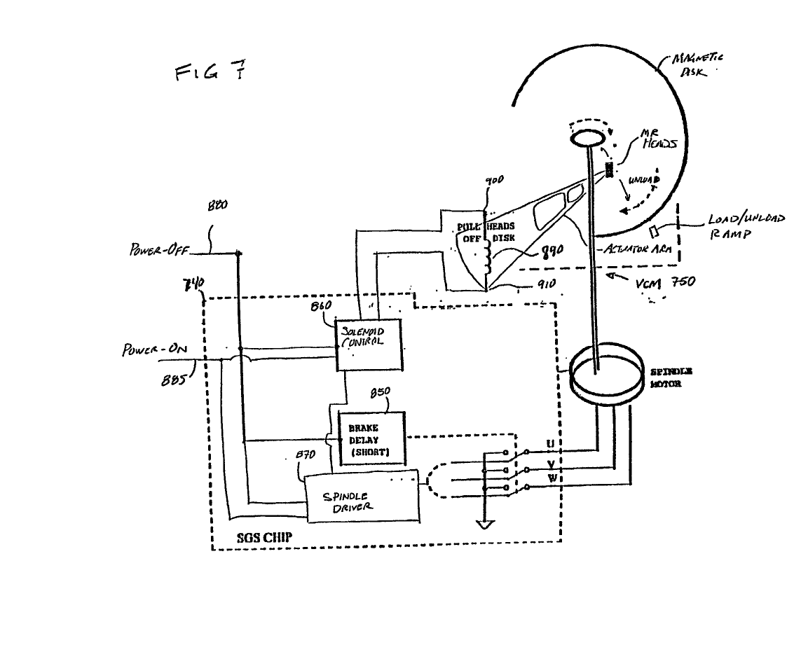

FIG. 9 illustrates a block diagram of a method for unloading heads according to an embodiment of the present invention.

Initially, the read/write (MR) heads fly above the surface of the magnetic disk, step 1110.

After detection of a head unload command, such as power-off signal 880, step 1120, solenoid driver 860 provides a first current pulse to solenoid 890, step 1130. The first current pulse is characterized by having a first magnitude and a first duration.

In response to the first current pulse, the velocity of the MR heads is determined, again preferably by measuring a back EMF voltage, step 1140.

In step 1150, the characteristics of the next current pulse are determined. More specifically, DSP 800 determines the duration of the next current pulse.

In the present embodiment of the present invention, the duration of the next current pulse is different from the duration of the first current pulse. In another embodiment, the second magnitude is deliberately different from the first magnitude, and the second duration is also deliberately different from the first duration. In general, it is desired that any two consecutive current pulses have at least different current durations. By having current durations that are, in general different for adjacent current pulses, the audible noise produced by unloading the MR heads onto the load/unload ramp is reduced.

The actual velocity of the MR heads is then compared to a desired velocity, step 1160. In the preferred embodiment, the desired velocity represented by a value representing a back EMF voltage stored in control store 710, is compared to the measured back EMF voltage. When the actual voltage is lower than the desired voltage, the actual velocity is low, and it is determined that a larger current magnitude is needed for the next current pulse, step 1170. When the actual voltage is higher than the desired voltage, the actual velocity is high, it is determined that a smaller current magnitude is needed for the next current pulse, step 1180.

After the characteristics of the next current pulse are determined, solenoid control 860 applies the next current pulse to solenoid 890, step 1190. The above process for determining and applying current pulses preferably repeats until the MR heads have been unloaded from the magnetic disk, step 1200.

In one embodiment of the present invention, when the back EMF voltage is zero for a predetermined amount of time after the MR heads are removed from the magnetic disk, it is assumed that the MR heads have reached a park location or ridge on the load/unload ramp.

In another embodiment of the present invention, the steps illustrated may be performed in a different order than that illustrated in FIG. 9.

In other embodiments of the present invention, step 1150 need not be performed. Instead, the actual velocity of the MR heads is first measured before any unloading current pulses are calculated or applied. In such embodiments, it is preferred that two adjacent current pulses still have different durations.

In both cases for loading and unloading the MR heads, in general, current pulses applied to solenoid 890 may be on the order of about 0.25 milliseconds to about 5 milliseconds and more particularly, from about 0.5 to 1.0 milliseconds, and preferably about 0.74 milliseconds, and have a magnitude of up to 0.500 amps in the present embodiment. The maximum magnitude typically varies according to the particular chip and VCM arrangement used to implement the present invention. The time between pulses, the time in which the back EMF is measured, is typically greater than 1 millisecond. This time period typically depends upon the inductance and the resistance of solenoid 890. The time between pulses can thus vary greatly depending upon actual implementation.

In one embodiment of the present invention, the duration pulses are determined by a pseudo-random number generator. As a result, each pulse duration preferably is not similar to other pulses relatively close in time. In another embodiment a predetermined sequence of pulse durations may be determined and stored in a memory such as control store 710. As a result, each pulse has a duration according to the predetermined sequence. Once the sequence of durations has been completed, the sequence can repeat.

In other embodiments of the present invention, groups of three or more consecutive current pulses are programmed to have different current magnitudes, different current durations, and permutations of the above. As a result of these different current durations among current pulses close in time, the audible noise produced by the loading or unloading process is reduced.

FIG. 10 illustrates a block diagram 1205 of an embodiment for determining a current magnitude. FIG. 10 includes summation units 1210 and 1220, a scaling unit 1230, an integrator 1240, an amplitude adjustment unit 1225, and a digital to analog converter (DAC) 1250. Signals to/from the block diagram include a measured velocity 1260, a desired velocity 1270, an output current magnitude 1280, and the next current duration 1295.

In operation, initially, measured velocity 1260 is subtracted from desired velocity 1270. As previously disclosed, measured velocity 1260 is typically embodied as the back EMF voltage produced from the voice coil motor 750 (solenoid 890). Further, the desired velocity 1270 also embodied as a back EMF voltage, may be a dynamic value calculated by control store 710, be a preprogrammed value stored in control store 710, and the like.

The velocity difference 1273 is typically scaled by scaling unit to form a scaled difference 1276. Values for the scaling unit constant Kp can be determined by one of ordinary skill depending on the velocity profile characteristics desired, for example to obtain critically damping, to adjust the amount of overshoot, and the like.

The velocity difference 1273 is integrated by integrator 1240 to form an integrated signal 1279. The integrated signal 1279 and scaled difference 1276 are then summed by summation unit 1220 to form a digital current magnitude 1290.

Next, based upon the duration of the current pulse desired, digital current magnitude 1290 is adjusted to become an output magnitude 1297. This step is preferably required due to the varying width of the current pulse. The block diagram 1205 is typically adjusted for a 50% duty cycle, on and off time. Thus, when the duration of the pulse increases beyond this 50%, the magnitude of the current pulse is typically reduced to reduce potential velocity overshoot.

Alternatively, the current magnitude can be increased if the pulse duration is less than 50% to avoid undershoot. In other embodiments, other duty cycles than 50% may be adjusted for within block diagram 1205, by adjusting parameters such as Kp. In one embodiment, the amount of power supplied by a current pulse is approximately held constant despite the lengthening or shortening of the current duration, by decreasing or increasing the current magnitude, respectively.

The output magnitude 1297 is then converted to (an analog) output current magnitude 1280 by DAC 1250, having a duration set by the current duration signal 1295.

In the preferred embodiment, components illustrated in block diagram 1205 are embodied within motor driver 740. Motor driver 740 is preferably an L6260L chip from SGS-Thomson, however, other motor driver chips are also contemplated.

Other techniques for forming the output current magnitude 1280 are contemplated in alternative embodiments of the present invention, for example using a derivative function in place of or in addition to integrator 1240.

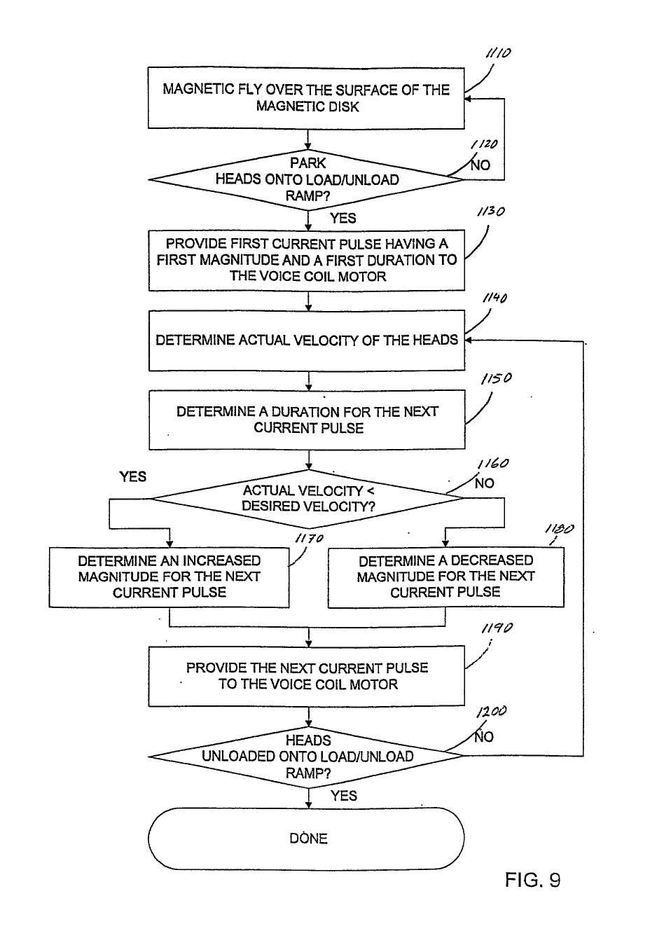

FIG. 11 illustrates a typical embodiment of the present invention. In FIG. 11, current profile 1300 illustrates the profile of the amount of current applied to solenoid 890 versus time. Current profile includes current pulses 1310-1360 and time periods 1370.

In the example in FIG. 11, the head is located at a starting position. Initially the velocity is determined, the amplitude (magnitude) of the first current pulse is determined, the duration of the first current pulse id determined, and then the first current pulse 1310 is applied to solenoid 890. During time period 1370, the velocity of the MR head is determined by measuring the magnitude of a back EMF.

The above process is then repeated for determining the characteristics of the second current pulse 1320 and applying second current pulse 1320 to solenoid 890. In this example, current pulse 1320 has a different duration than current pulse 1310. Again, during time period 1370, the velocity of the MR head is again determined, and in response a third current pulse 1330 is determined and applied.

The process typically repeats, as shown in this example, with adjacent current pulses preferably having different durations. As can be seen by comparing current pulses 1340-1360, some current durations may be similar, but preferably, no more than two consecutive current durations should be similar.

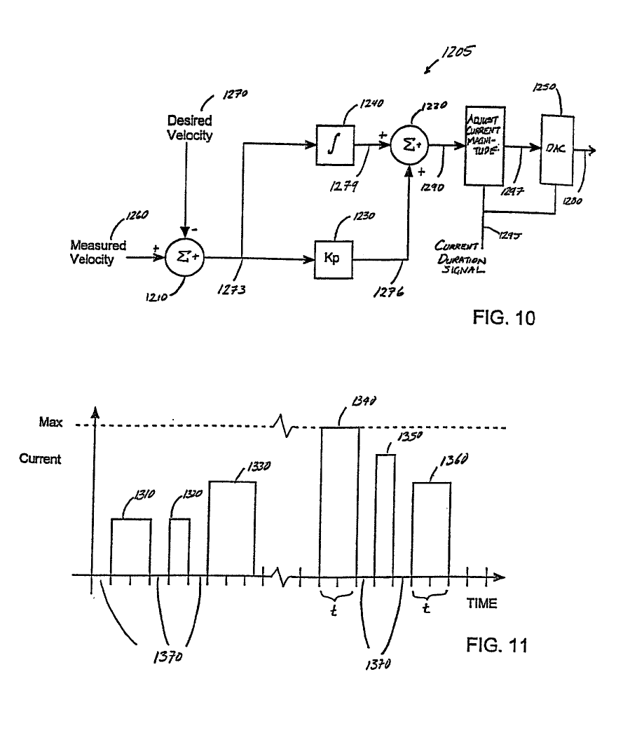

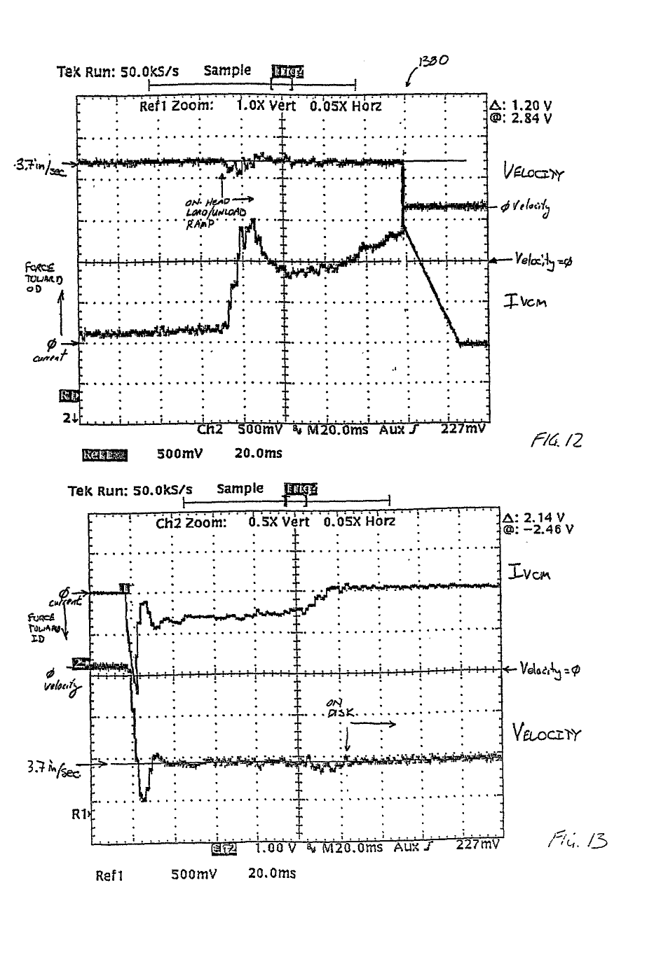

FIGS. 12 and 13 illustrate two examples according to embodiments of the present invention. FIG. 12 illustrates a head unload embodiment plotting the average amount of current applied to the voice coil motor, Ivcm, and head velocity both versus time. FIG. 13 illustrates a head load embodiment plotting the average amount of current applied to the voice coil motor, Ivcm, and head velocity both versus time.

As can be seen in FIG. 12, Jvcm is relatively small when the MR heads are above the magnetic disk, however Ivcm greatly increases when the MR heads are loaded onto the load/unload ramp due to the friction. In this example, the magnitude of the current pulses vary, and the duration of the current pulses, that are not illustrated here, also vary. As illustrated at location 1380, Ivcm peaks while the velocity drops to zero, indicating that the MR head has reached a parking location.

As can be seen in FIG. 13, Ivcm is large when the MR heads are on the load/unload ramp due to the friction, and relatively small when the MR heads are above the magnetic disk. In this example, the magnitude of the current pulses vary to a lesser extent, and the duration of the current pulses, that are not illustrated here, also vary.

Conclusion

In the foregoing specification, the invention has been described with reference to specific exemplary embodiments thereof. Many modifications or changes are readily envisioned in alternative embodiments of the present invention, for example, in the embodiments above, the magnitudes of the pulses are adjusted according to the duration of the pulse. As an example, in the case where the magnitude of the current pulse is high and the current duration is “above average” the magnitude of the current pulse is adjusted downwards because the current duration is long. As another example, in the case where the magnitude of the current pulse is very short and the duration is “below average” the magnitude of the current pulse is adjusted upwards.

In another embodiment, the velocity profile is not necessarily a constant profile but may be linearly increasing or decreasing, may be non-linear increasing or decreasing, may have portions with increasing velocity and regions with decreasing velocity, and the like. In such an embodiment, the desired velocity would be a function of time, thus the desired velocity function could be stored in control store 710 or calculated on the fly by DSP 800.

In one embodiment of the present invention, the magnitudes of the current pulses may follow a predetermined pattern, and repeat after a certain number of pulses. In such a case, DSP 800 varies the duration of such pulses to obtain the desired velocities.

In one embodiment of the present invention, if the magnitudes of pulses are below a predetermined value, the duration of the pulses are not varied. In such a case, the duration of the pulses may be of the same predefined duration, for example 2.5 milliseconds, 5 milliseconds, etc. However, if the magnitudes of the pulses are above a predetermined value, the duration of the pulses is varied as disclosed above. For example, in an embodiment where pulse duration is set according to a predefined sequence {p1, p2, p3, . . . p20}, when the current magnitude is below a threshold current I, pulses may have duration p0; when the current magnitude is greater than or equal to the threshold current I, pulses will have duration p1, p2, p3, . . . p20, p1, p2, . . . p20, etc.

The disclosed embodiment utilizes voice coil motor driver 740 and DSP 800 to perform many of the disclosed calculations, decision making, etc., however it should be understood that such functionality may be split apart and be performed by individual functional components or other combinations thereof.

It should be understood that the MR head velocity is represented by a back EMF voltage measurement in the present embodiment. Other methods for presenting and determining the MR head velocity are also contemplated, for example an electrical signal from optical, mechanical, or other electrical sensors, such as capacitors.

The presently claimed inventions may also be applied to other areas of technology such as mass storage systems for storage of video data, audio data, textual data, program data, or any computer readable data in any reproducible format.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A method for repositioning a read/write head from a parking location to a position adjacent a surface of a magnetic disk with reduced audible noise, the read/write head disposed on an actuator arm having a voice coil motor, comprising:
receiving a read/write head load signal;
applying a first current pulse to the voice coil motor in response to the read/write head load signal, the first current pulse having a first amplitude and a first duration;
determining a back electromotive force voltage in the voice coil motor;
determining a read/write head velocity in response to the back electro-motive force voltage;
determining a difference between the read/write head velocity and a desired read/write head velocity;
using the difference between the read/write head velocity and the desired read/write head velocity to determine a second duration for a second current pulse; and
applying the second current pulse to the voice coil motor.

2. The method of claim 1 wherein the parking location is on a load/unload ramp.

3. The method of claim 1 further comprising unloading the read/write heads from a load/unload ramp in response to applying the second current pulse.

4. The method of claim 1 further comprising accelerating the magnetic disk to an operating speed.

5. The method of claim 1 wherein the first duration ranges from approximately 25 milliseconds to approximately 5 milliseconds.

6. The method of claim 1 wherein the first amplitude has a maximum amplitude of approximately 500 milliamps.

7. A method for repositioning a read/write head from a position adjacent a surface of a magnetic disk to a parking location having reduced audible noise, the read/write head disposed on an actuator arm having a voice coil motor, comprising:
receiving a read/write head unload signal;
applying a first current pulse to the voice coil motor in response to the read/write head load signal, the first current pulse having a first amplitude and a first duration;
determining a read/write head velocity in response to the first current pulse;
comparing the read/write head velocity to a desired read/write head velocity to form a difference velocity;
determining a second amplitude and a second duration for a second current pulse in response to the difference velocity, the second duration different from the first duration and the second amplitude different from the first amplitude; and
applying the second current pulse to the voice coil motor.

8. The method of claim 7 wherein the first duration has a maximum duration of approximately 5 milliseconds.

9. The method of claim 7 wherein the first amplitude has a maximum amplitude of approximately 500 milliamps.

10. The method of claim 7 wherein the total charge for the second current pulse has a maximum charge of approximately 2.5 millicoulombs.

11. The method of claim 7 wherein the second amplitude and the first amplitude are predetermined.

12. The method of claim 7 wherein determining a read/write head velocity in response to the first current pulse comprises measuring an induced back-electromotive force voltage with the voice coil motor.

13. The method of claim 7 wherein the parking location is on a load/unload ramp.

14. The method of claim 7 further comprising loading the read/write heads to a load/unload ramp in response to applying the second current pulse.

15. A system having a storage device including a magneto-resistive head for repositioning the magneto-resistive head, the storage device further comprising:
an actuator arm having a voice coil motor disposed on one end and the magneto-resistive head disposed on another end, the voice coil motor for generating a back electromotive force;
a voice coil motor driver coupled to the voice coil motor for applying a first current pulse to the voice coil motor, the first current pulse having a first amplitude and a first duration;
a first processor coupled to the voice coil motor and to the voice coil motor driver for determining a difference between the back electromotive force voltage and a predetermined back electromotive force voltage, and for determining a second amplitude in response to the difference, the second amplitude different from the first amplitude; and
a second processor coupled to the first processor for determining a second duration, the second duration different from the first duration,
wherein the voice coil motor driver is also for applying a second current pulse to the voice coil motor, the second current pulse having the second amplitude and the second duration.

16. The system of claim 15 wherein the second amplitude and the first amplitude are predetermined.

17. The system of claim 15 wherein the first duration has a maximum duration of approximately 5 milliseconds.

18. The system of claim 15 wherein the storage device further comprises a spindle motor coupled to a magnetic disk for rotating the magnetic disk at a predefined speed in response to the load signal.

19. The system of claim 15 wherein the second current pulse biases the magneto-resistive head up a load/unload ramp.

20. The system of claim 15 wherein the second current pulse biases the magneto-resistive head towards a magnetic disk.

21. The method of claim 1 wherein the difference between the read/write head velocity and the desired read/write head velocity is also used to determine a second amplitude for the second pulse.

22. The method of claim 21 wherein the second amplitude is different from the first amplitude and the second duration is different from the first duration.

23. A method for repositioning a read/write head from a position adjacent a surface of a magnetic disk to a parking location with reduced audible noise, the read/write head disposed on an actuator arm having a voice coil motor, comprising:
receiving a read/write head unload signal;
applying a series of current pulses to the voice coil motor in response to the read/write head unload signal until the read/write head reaches the parking location, each current pulse having an amplitude and a duration;
after a first number of current pulses, determining a back electro-motive force voltage in the voice coil motor;
determining a read/write head velocity in response to the back electro-motive force voltage;
determining a difference between the read/write head velocity and a desired read/write head velocity; and
using the difference between the read/write head velocity and the desired read/write head velocity to determine a duration for each of a next first number of pulses,
wherein no two consecutive pulses in the series have the same duration.

24. The method of claim 23 wherein no two consecutive pulses in the series have the same amplitude.

25. The method of claim 23 wherein the first number is one.

26. The method of claim 23 wherein the first number is three.

27. A method for repositioning a read/write head from a parking location to a position adjacent a surface of a magnetic disk with reduced audible noise, the read/write head disposed on an actuator arm having a voice coil motor, comprising:
receiving a read/write head load signal;
applying a series of current pulses to the voice coil motor in response to the read/write head load signal until the read/write head reaches the position adjacent a surface of a magnetic disk, each current pulse having an amplitude and a duration;
determining a read/write head velocity in response to the back electro-motive force voltage;
determining a difference between the read/write head velocity and a desired read/write head velocity; and
using the difference between the read/write head velocity and the desired read/write head velocity to determine a duration for each of a next first number of pulses,
wherein no two consecutive pulses in the series have the same duration.

28. The method of claim 27 wherein no two consecutive pulses in the series have the same amplitude.

29. The method of claim 27 wherein the first number is one.

30. The method of claim 27 wherein the first number is three.
